(19) United States
(12) Patent Application Publication
(10) Pub. No.: US 2022/0205446 A1
(43) Pub. Date: Jun. 30, 2022

(54) THICK MATTER PUMP AND METHOD FOR CONVEYING THICK MATTER

(71) Applicant: Putzmeister Engineering GmbH, Aichtal (DE)

(72) Inventor: Knut Kasten, Ostfildern (DE)

(21) Appl. No.: 17/622,583

(22) PCT Filed: Jun. 25, 2020
(86) PCT No.: PCT/EP2020/067792

§ 371 Date: Dec. 23, 2021

(30) Foreign Application Priority Data
Jun. 27, 2019 (DE) 10 2019 117 356.6

(51) Int. Cl. F04C 13/00; F04C 9/00

(52) U.S. Cl. CPC F04C 13/002; F04C 2210/1033; F04C 9/00

(57) ABSTRACT

A thick matter pump with a conveying chamber which extends along a closed path from an inlet opening via an outlet opening back to the inlet opening, with the result that the conveying chamber forms a first connecting path and a second connecting path between the inlet opening and the outlet opening. A first piston performs a conveying movement along the first connecting path of the conveying chamber, with the result that, by way of the conveying movement, thick matter is conveyed out of the conveying chamber through the outlet opening, and thick matter is introduced through the inlet opening into the conveying chamber. A shut-off element is arranged in the conveying chamber, which shut-off element, in a first state, shuts off the second connecting path and, in a second state, opens the second connecting path in order to permit a movement of the first piston along the second connecting path. Moreover, the invention relates to a method for conveying thick matter.

### BACKGROUND

The invention relates to a thick matter pump and a method for conveying thick matter.

Thick matter pumps are used for conveying thick matter, for example fresh concrete or mortar. The thick matter is sucked from a storage supply and conveyed towards an outlet of the thick matter pump. Typical thick matter pumps from the prior art comprise a plurality of conveying cylinders, which is why the pumps occupy a lot of space, EP 3 282 124 A1. A thick matter pump with a conveying chamber which extends along a circular path is known from JP 61053481.

The problem underlying the invention is that of introducing a thick matter pump and an associated method, so that there is a reduction in friction during operation of the thick matter pump. Starting with the prior art, as indicated, the problem is solved by the features of the independent claims. Advantageous embodiments are specified in the dependent claims.

### SUMMARY OF THE INVENTION

The thick matter pump according to the invention comprises a conveying chamber, which extends along a closed path from an inlet opening, via an outlet opening, back to the inlet opening. The conveying chamber forms a first connecting path and a second connecting path between the inlet opening and the outlet opening. A first piston, which is designed to perform a conveying movement along the first connecting path of the conveying chamber, is arranged in said conveying chamber, so that with the conveying movement thick matter is conveyed from the conveying chamber through the outlet opening, and thick matter is introduced into the conveying chamber through the inlet opening. A shut-off element which shuts off the second connecting path in a first state, and opens up the second connecting path in a second state, is arranged in the conveying chamber, in order to allow a movement of the first piston along the second connecting path. A wall shell delimiting the conveying chamber is attached to the first piston. The wall shell extends over the entire length of the conveying chamber and is moved together with the first piston. When the wall shell is moved together with the piston, the conveyed material travels at substantially the same speed along the conveying chamber as the wall shell. In this way, friction between the wall of the conveying chamber and the conveyed material is reduced, so that friction losses while the pump is operating are reduced.

With regard to the reduction in friction losses, it is advantageous for the wall shell connected to the piston to be large-sized in the circumferential direction. The circumferential direction extends in a plane which forms a right angle with the movement direction of the piston. In other words, terms such as circumferential direction, circumferential portion, each relate to the cross section of the conveying chamber. In contrast to this, the direction in which the piston moves along the conveying chamber is referred to as the longitudinal direction of the conveying chamber. The greater the size of the wall shell in the circumferential direction, the smaller the circumferential portion of the conveying chamber in which the conveyed material moves relative to the wall of the conveying chamber, and the greater the reduction in friction losses.

In order to propel a movement of the piston along the conveying chamber, the thick matter pump may comprise a drive motor. A connecting element arranged radially outside a wall component of the conveying chamber, by means of which the movement of the piston is driven, may extend between the drive motor and the piston. The extension of the wall shell in the circumferential direction is preferably greater than the extent of the connecting part in a plane spanned by the circumferential direction. The wall shell may extend over at least 30°, preferably at least 60°, more preferably at least 90°, in the circumferential direction. This specification relates to an angle which is covered by the wall shell, in relation to a center point of the conveying chamber. The extent of the wall shell in the circumferential direction may be constant over the length of the conveying chamber.

In one embodiment, the shut-off element is a shut-off valve which, in the first state, is arranged in the second connecting path and, in the second state, is spaced apart laterally from the second connecting path, so that the first piston can pass through the second connecting path. The shut-off valve is switched between the first state and the second state by a movement of said shut-off value in the lateral direction. A movement in the lateral direction is generally characterized as a movement which forms an angle with the movement direction of the piston along the conveying chamber, so that the shut-off valve moves away from the connecting path or moves closer to the connecting path. The movement of the shut-off valve may be a movement in the radial direction, so that the movement direction of the shut-off valve forms a right angle with the movement direction of the piston.

The thick matter pump may be set up in such a manner that the second connecting path is shut off during the conveying movement of the first piston, and that the second connecting path is opened up in an intermediate phase between a first conveying movement and a second conveying movement of the first piston. The first piston can then perform a continuous movement along the conveying chamber, wherein adjusting the shut-off element brings about a switchover between conveying phases, in which thick matter is conveyed, and intermediate phases, in which no thick matter is conveyed.

In an alternative embodiment, the shut-off element is a second piston, which is likewise designed to perform a conveying movement along the first connecting path of the same conveying chamber. The movement direction of the conveying movement of the first piston may coincide with the movement direction of the conveying movement of the second piston. The second piston can shut off the second connecting path during the conveying movement of the first piston, and vice versa. If the second piston shuts off the second connecting path, the second piston within the meaning of the invention is a shut-off element in the first state. If the second piston has a different position in the conveying chamber, the second connecting path is open, so that the second piston is a shut-off element in the second state.

The thick matter pump may be designed in such a manner that the second piston is at a standstill during the conveying movement of the first piston. The standstill may continue for at least 60%, preferably at least 80%, of the conveying movement of the first piston, and extend further, preferably over the entire conveying movement of the first piston. During the conveying movement of the first piston, the second piston may be arranged within the conveying chamber in an intermediate position between the outlet opening and the inlet opening. Because there is no direct connection between the inlet and the outlet, the static pressure which is present at the pump outlet can be maintained in the conveying chamber.

The processes and states which have been described here in connection with the conveying movement of the first piston apply conversely to the conveying movement of the second piston. The first piston and the second piston are interchangeable in terms of these processes.

In the case of the thick matter pump according to the invention, the conveying flow may be interrupted between the end of the conveying movement of the first piston and the start of the conveying movement of the second piston. This interruption of the conveying flow can be avoided by an embodiment of the invention in which the conveying chamber comprises an inlet opening and two outlet openings, and in which three pistons are arranged in the conveying chamber. In the case of a thick matter pump with two pistons, an interruption of the conveying flow comes about in the phase in which one of the pistons moves along the second connecting path from the outlet opening to the inlet opening. If the thick matter pump has a third piston, the phase in which a first piston moves away from the outlet opening to the inlet opening can be bridged, in that a second piston blocks the (third) connecting path between the first outlet opening and the second outlet opening, and the third piston conveys thick matter through the first outlet opening. The first outlet opening and the second outlet opening can be connected to one another by a common outlet pipe. The thick matter pump may comprise a control unit which controls the movement of the three pistons in a suitable manner.

The conveying chamber may be circular in cross section, for example, or it may take the shape of a circular segment. The cross section may be constant along the length of the conveying chamber. A plane which forms a right angle with the movement direction of the pistons is referred to as the cross section. The longitudinal direction corresponds to the movement direction of the pistons. Viewed in the longitudinal direction, the conveying chamber may form a closed path. In this way, it is possible for the pistons to be able to move repeatedly along the conveying chamber without reversing their movement direction. The longitudinal direction of the conveying chamber may span a circular path, so that the pistons move along a circular course. In combination with a circular cross section, a conveying chamber in the form of a torus is produced.

The thick matter pump may comprise a drive motor, with which the movement of the first piston is propelled along the conveying chamber. In the case of a conveying chamber which defines a circular path, a drive shaft for the conveying movement may be provided, which drive shaft is coaxial with the central axis of the circular path. The first piston may be attached to the drive shaft by a connecting element extending in the radial direction.

A second drive motor for moving the shut-off element may be provided. If the shut-off element is a shut-off valve, the second drive motor can drive a pivoting movement or a linear movement or a combination of the two, for example.

If the shut-off element is a second piston, the second drive motor can be used to drive the first piston and the second piston independently of one another. This makes it possible to move the pistons at different speeds, or to move one piston, while the other piston is at a standstill.

Designs in which two pistons are driven by a joint drive motor are also possible. For this purpose, each piston can be assigned a clutch, wherein the clutches are coupled with the same drive motor. In one embodiment, each piston is assigned a dual clutch, wherein the piston is coupled with the drive motor in a first state of the dual clutch, and in a second state of the dual clutch, the piston is coupled with a frame of the thick matter pump. The drive may be designed in such a manner that it turns at a constant speed. The alternate movement of the pistons can be achieved through a suitable coupling of the pistons with the drive shaft. In all cases, the thick matter pump may comprise a control unit which controls drive motors and/or clutches in a suitable manner.

The first piston and/or the second piston may be configured in such a manner that a circumferential face of the piston seals with the wall face of the conveying chamber. The sealing circumferential face may extend over the entire circumference of the piston, apart from a portion occupied by the connecting element.

It is also possible for a wall shell to be attached to the piston, which wall shell is moved along with the piston. The wall shell may limit the conveying chamber, in other words form part of the wall of the conveying chamber. The wall shell may extend over the entire length of the conveying chamber. In this way, the friction loss in the thick matter pump can be reduced, because a relative movement between the conveyed thick matter and the wall of the conveying chamber takes place during a conveying movement of the respective piston only in those regions which are not covered by the wall shell.

The thick matter pump may comprise a first wall shell which is connected to the first piston, and a second wall shell which is connected to the second piston. Viewed in the cross section of the conveying chamber, the first wall shell may extend along a different circumferential portion to the second wall shell. The first wall shell and the second wall shell may overlap one another in the circumferential direction or be free from an overlap. The second wall shell may exhibit the same features as those described in connection with the first wall shell.

Viewed in cross section, the conveying chamber may have a circumferential portion, which is kept free from both the first wall shell and also from the second wall shell. This circumferential portion may be oriented to the inlet opening and/or the outlet opening of the thick matter pump. The thick matter can then enter or leave the conveying chamber without being adversely affected by the wall shell.

In the circumferential portion, which is kept free from the wall shells, the wall of the conveying chamber can be formed by a housing of the thick matter pump. The housing may be limited to this circumferential portion. A housing which overlaps one or both wall shells is also possible. A housing part arranged between the wall shells can delimit the conveying chamber in cross section in a straight line, so that the conveying chamber is shaped like a circular segment in cross section. The inlet opening and/or the outlet opening may be configured in this housing part.

If the wall of the conveying chamber is composed of wall shells and housing parts which extend over different circumferential portions of the conveying chamber, it is advantageous for a sealing element to be arranged at the transition between a wall shell and a housing part or at the transition between two wall shells. The sealing element may be designed as a sealing ring which extends over the entire length of the conveying chamber. While the thick matter pump is operating, a relative movement between adjacent portions of the wall of the conveying chamber takes place in the region of the sealing rings.

The inlet opening and the outlet opening may be offset relative to one another, viewed in the longitudinal direction of the conveying chamber. If the conveying chamber forms a closed path, there are two connecting paths along which it is possible to move from the inlet opening to the outlet opening in the conveying chamber. The thick matter pump may be designed in such a manner that the first connecting path is used for conveying thick matter, while the second connecting path is shut off. The first connecting path may extend over at least 70%, preferably at least 80%, more preferably at least 90% of the length of the conveying chamber.

In the circumferential position viewed in cross section, the inlet opening and the outlet opening may intersect. Corresponding positions of the inlet opening and the outlet opening viewed in the cross section of the conveying chamber are also possible.

There are various possibilities with regard to the circumferential position of the inlet opening and the outlet opening. If the conveying chamber extends along a circular path, the inlet opening and/or the outlet opening may extend in a radial direction relative to a central axis of the circular path. The inlet opening and/or the outlet opening may point inwardly (so in the direction of the central axis). It is also possible for the inlet opening and/or the outlet opening to point radially outwards in the opposite direction. Other positions between these two positions aligned with the radial direction are also possible.

The first piston may have a circumferential portion which travels over the outlet opening and/or the inlet opening during the conveying movement. This circumferential portion may be formed by a connection piece connected to the piston, wherein the connection piece is made of a harder material than the piston. In particular, the connection piece may be made of hard metal. Stones and granular constituents of the thick matter can be broken up between the connection piece and an edge of the inlet opening or outlet opening which is passed over. The respective region of the inlet opening and/or of the outlet opening may be formed by an insertion piece which is likewise formed from a harder material, for example from a hard metal.

In order to prevent stones from becoming jammed between the connection piece and the wall of the conveying chamber, the connection piece may have a front face pointing in the movement direction, which forms an angle of at least 60°, preferably at least 70°, more preferably at least 80°, with the circumferential face of the piston. In one embodiment, the front face is a flat face which is oriented at right angles to the movement direction.

The first piston may comprise a circumferential portion which forms a seal with the wall of the conveying chamber, without passing over the inlet opening and the outlet opening. This circumferential portion of the piston may be provided with a sealing package which bears against the wall of the conveying chamber. The wall of the conveying chamber in this circumferential portion may be formed by the wall shell of the other piston.

The sealing package and the connection piece may be configured as expendable parts which are routinely replaced while the thick matter pump is in operation. The thick matter pump may be configured in such a manner that the expendable parts can be replaced without any major dismantling of the thick matter pump. For example, it may be sufficient for a housing portion arranged between the wall shell of the first piston and the wall shell of the second piston to be removed, in order to gain access to the expendable parts. The piston may have a cavity arranged between its front face and its rear face, within which the expandable parts are fitted.

A prefilling container may be connected to the inlet opening of the thick matter pump. While the pump is operating, the prefilling container can be topped up with as much thick matter as is being conveyed by the thick matter pump through the outlet opening. A conveying line may be connected to the outlet opening of the thick matter pump, along which the thick matter is conveyed to a desired delivery location.

In the case of a thick matter pump with two pistons, there may be an interruption in the conveying flow when the first piston and the second piston are moved together. In order to bridge the interruption in the conveying flow, the thick matter pump may be fitted with a supplementary conveying cylinder. The supplementary conveying cylinder may be coupled with the outlet end of the thick matter pump, by a connecting pipe for example, which extends between the outlet opening and the supplementary conveying cylinder, or between the conveying line and the supplementary conveying cylinder.

The supplementary conveying cylinder may be set up in such a manner that it performs a forwards movement, while the pistons of the thick matter pump are moved together. The conveying cylinder may be set up in such a manner that it performs a backwards movement when one of the pistons of the thick matter pump conveys thick matter through the outlet opening. Thick matter can be conveyed from the interior of the conveying cylinder along the conveying line on the forwards movement. Thick matter can be collected in the interior of the conveying cylinder on the backwards movement. An active drive in the form of a hydraulic drive, for example, can be provided for the forwards movement of the piston arranged in the conveying cylinder. The backwards movement of the piston may likewise take place through the active drive. It is also possible for the piston to be moved back passively by the pressure of the thick matter being conveyed.

The invention moreover relates to a method for conveying thick matter. A first piston is moved in a conveying chamber which extends along a closed path from an inlet opening via an outlet opening back to the inlet opening, so that the conveying chamber forms a first connecting path and a second connecting path between the inlet opening and the outlet opening. A wall shell which delimits the conveying chamber and extends over the entire length of the conveying chamber and which is moved together with the first piston is attached to said first piston. In a first phase, the first piston is moved along the first connecting path from the inlet opening in the direction of the outlet opening, in order to convey thick matter through the outlet opening and to introduce thick matter through the inlet opening into the conveying chamber, while the second connecting path is shut off. In a second phase, the first piston is moved along the second connecting path.

The process involved in conveying thick matter may comprise one or more of the following steps. The first piston may pass over the inlet opening at the start of the conveying movement. The first piston may pass over the outlet opening at the end of the conveying movement. There may be an intermediate phase in which the first piston is moved along the second connecting path, and in which no thick matter is conveyed. The intermediate phase may lie between the end of a first conveying movement and the start of a second conveying movement.

At the start of the conveying movement of the first piston, the part of the conveying chamber lying between the first piston and the outlet opening may be filled with thick matter. As the conveying movement of the first piston continues, the volume in this portion of the conveying chamber becomes smaller and thick matter leaves the conveying chamber through the outlet opening. At the same time, the volume in the portion of the conveying chamber enclosed between the first piston and the shut-off element is increased. This portion is accessible via the inlet opening, so that further thick matter is sucked through the inlet opening into this portion of the conveying chamber. The conveying movement ends when the first piston has reached the outlet opening, so that as the first piston continues to move, no further thick matter leaves from the outlet opening.

In this state, the portion of the conveying chamber arranged between the first piston and the inlet opening has reached its maximum length. This portion is now completely filled with thick matter. The transition to the next conveying movement follows.

In the case of embodiments having a first piston and a second piston, there is a transition to the conveying movement of the second piston, in that the first piston and the second piston are moved together, so that the first piston opens up the outlet opening and the second piston travels over the inlet opening. The conveying movement of the second piston which follows coincides with the conveying movement of the first piston, as described.

In embodiments which have a first piston and a shut-off valve, the shut-off valve is removed from the conveying chamber in the transitional phase, so that said first piston can pass through the shut-off valve. Once the first piston has passed over the input opening and the shut-off valve is closed again, the next conveying movement can begin.

The method can be improved with further features which are described in the context of the thick matter pump according to the invention. The thick matter pump can be improved with further features which are described in connection with the method according to the invention. The invention also includes embodiments in which there is no wall shell which is moved with the piston.

### BRIEF DESCRIPTION OF THE DRAWINGS

The invention is described by way of example below with reference to the attached drawings with the help of advantageous embodiments. In the figures:

FIG. 1: shows a concrete pump vehicle having a thick matter pump according to the invention;

FIG. 2: shows a perspective representation of a thick matter pump according to the invention;

FIG. 3: shows the thick matter pump from FIG. 2 as a horizontal section;

FIG. 4: shows a schematic depiction of a thick matter pump according to the invention;

FIG. 5: shows different sectional views from FIG. 4;

FIG. 6, 7: show the view according to FIG. 5 in an alternative embodiment of the invention;

FIG. 8: shows a detail of the thick matter pump according to the invention as an enlarged depiction;

FIG. 9: shows a thick matter pump according to the invention as a vertical section;

FIG. 10-12: show schematic representations of various embodiments of thick matter pumps according to the invention;

FIG. 13: shows an operating sequence of the thick matter pump according to the invention;

FIG. 14-16: show alternative embodiments of thick matter pumps according to the invention.

### DETAILED DESCRIPTION

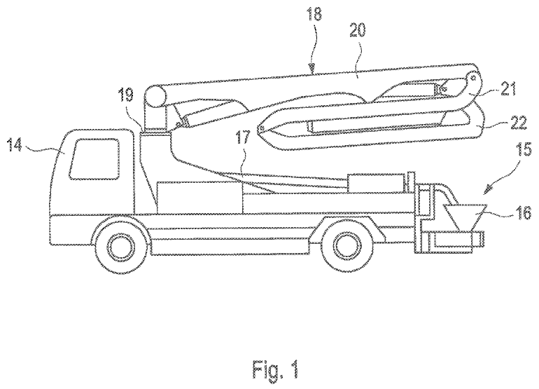

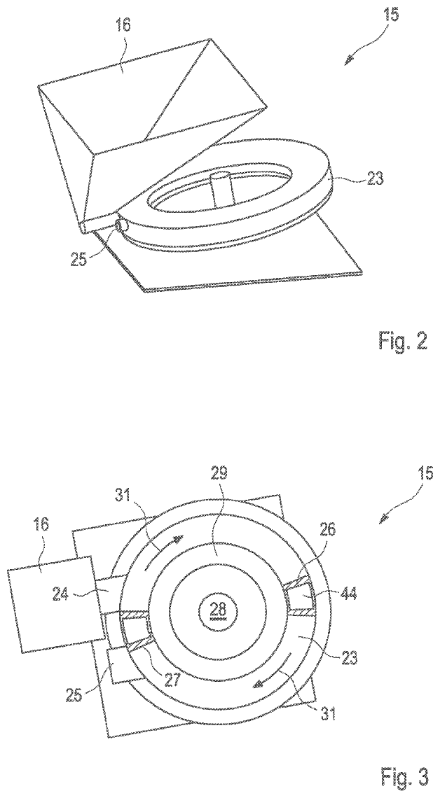

A truck 14 shown in FIG. 1 is fitted with a concrete pump 15 which conveys liquid concrete from a pre-filling container 16 through a conveying line 17. The concrete pump is a thick matter pump 15 within the meaning of the invention. The conveying line 17 extends along a mast arm 18 which is rotatably mounted on a slewing ring 19. The mast arm 18 comprises three mast arm segments 20, 21, 22 which are connected to one another in an articulated manner. The mast arm 18 can switch between a folded-in state and a folded-out state, in that the mast arm segments 20, 21, 22 are pivoted relative to one another via the articulations. The conveying line 17 extends to beyond the distal end of the third mast arm segment 22, so that in the folded-out state of the mast arm 18, the liquid concrete can be delivered in a region remote from the concrete pump 15.

The thick matter pump 15 comprises a conveying chamber 23 which defines a circular path. An inlet opening 24 of the thick matter pump 15 is attached to the pre-filling container 16. An outlet opening 25 of the thick matter pump 15 is attached to the conveying line 17. A first piston 26 and a second piston 27 are arranged in the conveying chamber 23, each of which pistons fills the cross section of the conveying chamber 23. The pistons 26, 27 are attached to a central drive shaft 28, so that said pistons 26, 27 can be driven independently of one another. A rotation of the drive shaft 28 is transmitted via connecting elements 29, 30 to the first piston 26 or the second piston 27, so that the pistons 26, 27 move in the movement direction 31 of the conveying movement along the circular path of the conveying chamber 23.

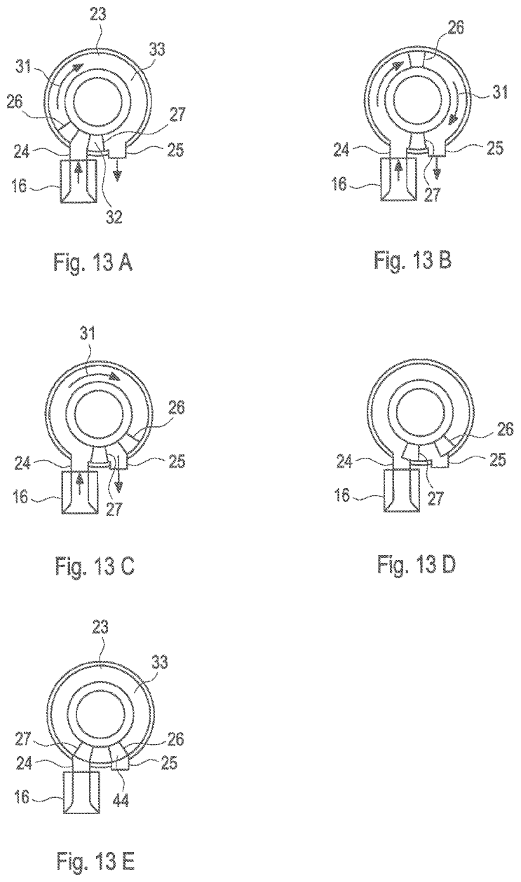

The process which takes place while the thick matter pump 15 is operating is explained with the help of FIG. 13. In a starting state (FIG. 13A), the second piston 27 is arranged in an intermediate position 32 between the inlet opening 24 and the outlet opening 25 and shuts off the short connecting path between the inlet opening 24 and the outlet opening 25.

The first piston 26 is coupled with the drive shaft 28, so that it completes a conveying movement in the conveying chamber 23. The conveying movement extends along the long connecting path 33 between the inlet opening 24 and the outlet opening 25. In the state according to FIG. 13A, the first piston 26 has passed over the inlet opening 24. With the further movement of the first piston 26 in the conveying direction, thick matter is conveyed out of the conveying chamber 23 through the outlet opening 25. Parallel to this, thick matter is sucked out of the prefilling container 16, so that the space between the second piston 26 and the inlet opening 24 at the end of the conveying movement is once again filled with thick matter. The sequence of the conveying movement of the first piston 26 is indicated by FIGS. 13A-13C.

At the end of the conveying movement, the first piston 26 travels over the outlet opening 25 (FIG. 13D), a residual quantity of thick matter is included between the first piston 26 and the second piston 27. The first piston 26 and the second piston 27 are moved together in the conveying direction 31, until the second piston 27 has passed over the inlet opening 24 and the first piston is in the intermediate position 32 between the inlet opening 24 and the outlet opening 25. The thick matter pump is then once again in the initial state according to FIG. 13A, wherein the positions of the pistons 26, 27 are reversed.

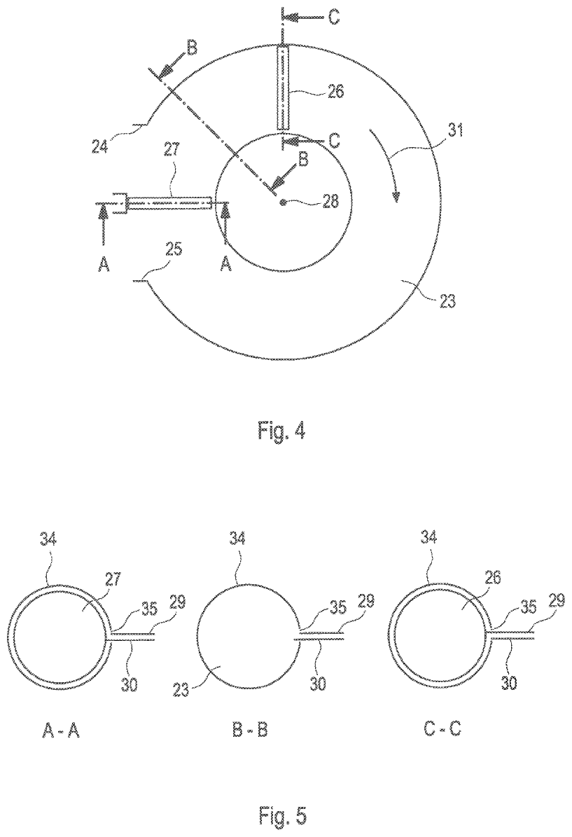

FIG. 4 shows the thick matter pump in a state in which the second piston 27 is arranged in the intermediate position 32 between the inlet opening 24 and the outlet opening 25 and the first piston 26 has covered part of the conveying path. According to the sectional depiction in FIG. 5, the first piston 26 and the second piston 27 are surrounded by a housing 34, wherein a sealing gap is formed between the circumference of the pistons 26, 27 and the housing 34. The housing 34 is interrupted on its outer side by the inlet opening 24 and the outlet opening 25. On the inner side, a circumferential slot 35, through which the connecting elements 29 extend, is formed, via which the pistons 26, 27 are coupled with the drive shaft 28. The connecting elements 29, 30 are configured as disk-shaped elements, so that said connecting elements 29, 30 fill the slot 35 over its entire length.

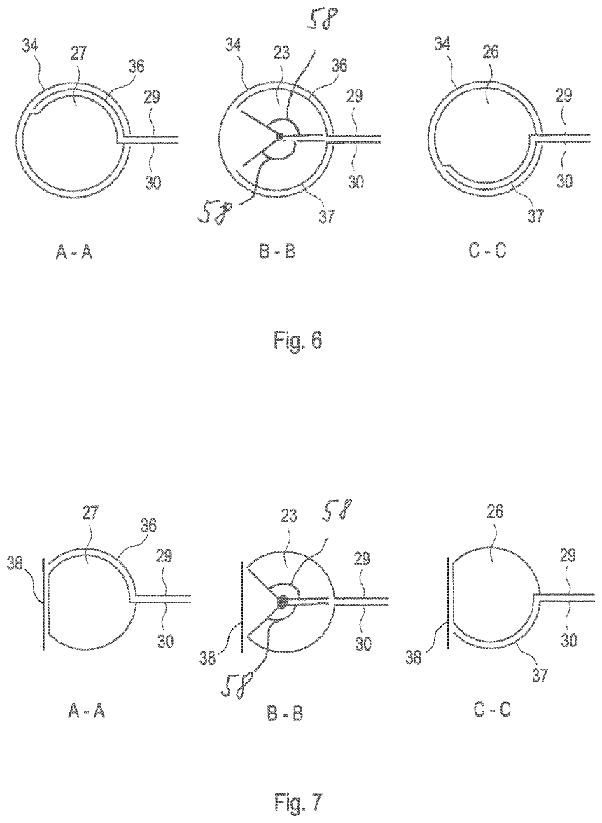

In the alternative embodiment according to FIG. 6, the first connecting element 29 is connected to a first wall shell 36, and the second connecting element 30 is connected to a second wall shell 37. The wall shells 36, 37 extend along the inner face of the housing 34, viewed in cross section, and over the entire length of the conveying chamber 23, viewed in the longitudinal direction. Each of the wall shells 36, 37 extends over a circumferential angle 58 of more than 90°. All in all, the two wall shells 36, 37 cover a circumferential angle 58 of more than 180°. A clearance which corresponds to the diameter of the inlet opening 24 and of the outlet opening 25 is contained between the peripheral ends of the wall shells 36, 37. This clearance is necessary so that the thick matter is able to enter the conveying chamber 23, or leave the conveying chamber 23. The internal friction in the thick matter pump is reduced by the wall shells 36, 37 moving along the conveying path together with the thick matter.

In the other alternative embodiment according to FIG. 7, the housing surrounding the wall shells 36, 37 is dispensed with. The wall shells 36, 37 themselves form the outer end of the conveying chamber 23. The housing is limited to a cylindrical housing part 38 which restricts the outer circumference of the conveying chamber 23. The inlet opening 24 and the outlet opening 25 are formed in the housing part 38.

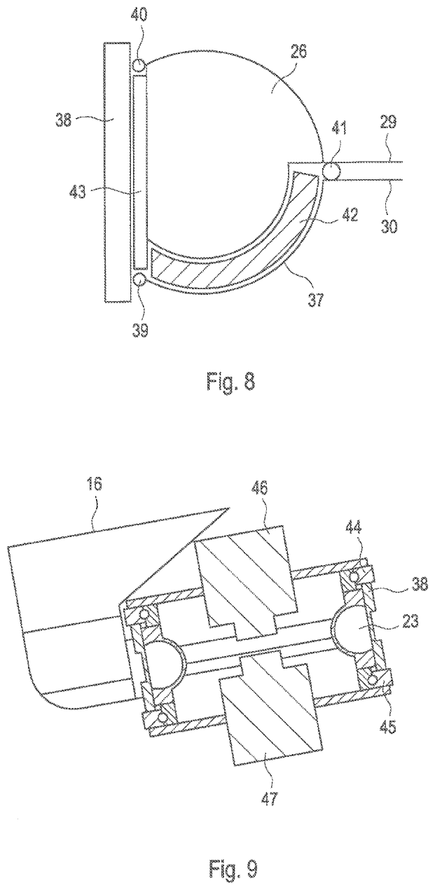

According to FIG. 8, a circumferential sealing ring 39 which extends over the entire length of the conveying chamber 23 is arranged between the wall shell 37 and the housing part 38. The conveying chamber is sealed at the transition between the wall shell 37 and the housing part 38 with the sealing ring 39. A second sealing ring 40 seals the transition between the other wall shell 36 and the housing part 38. A third sealing ring 41 is arranged between the connecting elements 29, 30.

The first piston 26 is provided with a sealing element 42 which extends over a circumferential portion of the piston 26. The sealing element 42 forms a seal between the first piston 26 and the wall shell 37 of the second piston 27.

An end piece 43 made of hard metal is arranged on a peripheral circumferential portion of the first piston 26. Stones and other granular constituents which become jammed between the piston 26 and an edge of the opening when the passing over the inlet opening 24 or the outlet opening 25 can be broken up by the hard metal end piece 43. The edges of the openings may be formed by corresponding hard metal inserts.

The hard metal end piece 43 and the sealing element 42 are expendable parts which have to be routinely replaced. The pistons 26, 27 each have an internal cavity 44 which is accessible from outside once the peripheral housing part 38 has been removed. Only the peripheral housing part 38 need therefore be detached, in order to replace the expendable parts, no further dismantling of the thick matter pump is required.

FIG. 9 shows a possible structural embodiment of the thick matter pump. Two roller bearings 44, 45 are arranged between the frame of the pump, to which the housing part 38 is connected, and the moved parts which turn with the drive shaft 28. A third roller bearing, which is not shown in FIG. 9, may be arranged between the parts moved using the first piston 26 and the parts moved using the second piston 27. A first drive motor 46 drives the first piston 26, a second drive motor 47 drives the second piston 27, as emerges even more clearly from the schematic depiction in FIG. 10.

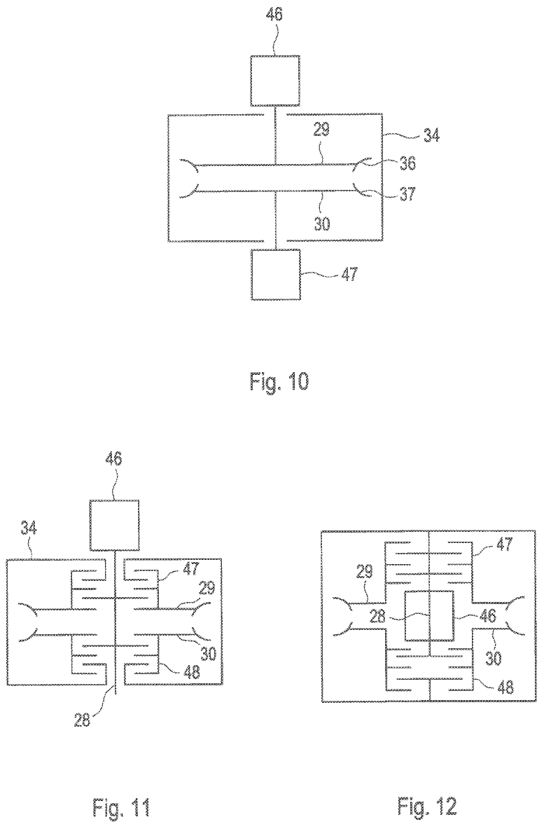

In the alternative embodiment according to FIG. 11, both pistons are driven by a shared drive motor 46. The first piston 26 is assigned a dual clutch 47 which couples the first piston either with the drive shaft 28 or with the housing 34. If the first piston 26 is coupled with the drive shaft 28, it follows the rotational movement of the drive shaft 28. If the first piston 26 is coupled with the housing 34, it has a fixed position relative to the housing 34. A corresponding dual clutch 48 is provided for the second piston 27. In the embodiment according to FIG. 12, the drive motor 46 is arranged between the dual clutches 47, 48. The function of the dual clutches 47, 48 is identical.

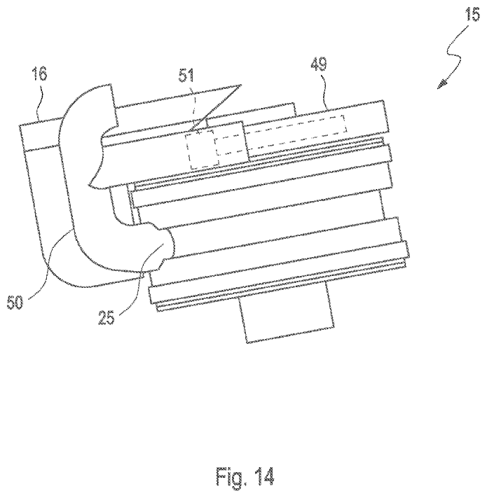

In the thick matter pump according to the invention, the conveying flow is interrupted when the pistons 26, 27 move jointly in the conveying direction 31. This is the case in the phase between the state according to FIG. 13D and the state according to FIG. 13A. If a continuous conveying flow is to be achieved, the thick matter pump according to FIG. 14 can be equipped with a supplementary conveying cylinder 49. A transition pipe 50, which creates the connection to the conveying pipe 17, is attached to the outlet opening 25. The supplementary conveying cylinder 49 is attached to the transition pipe.

A conveying piston 51 of the conveying cylinder 49 is retracted, while thick matter is conveyed through the outlet opening 25 of the thick matter pump. If the conveying flow is interrupted by the outlet opening 25, the conveying piston 51 can be moved forwards again hydraulically, in order to bridge the interruption in the conveying flow. The thick matter pump is therefore capable of conveying liquid concrete in a continuous conveying flow.

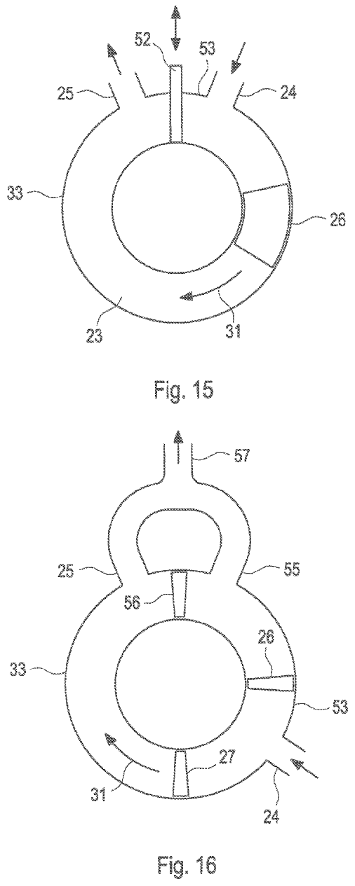

FIG. 15 shows an embodiment of a thick matter pump in which the second connecting path 53 of the conveying cavity 23, which is arranged between the outlet opening 25 and the inlet opening 24, is provided with a shut-off valve 52, which can be moved in a radial direction. In a first state, which is depicted in FIG. 15, the shut-off valve 52 shuts off the second connecting path 53. In a second state, which is not shown, the shut-off valve 52 is moved outwardly, so that the first piston 26 is able to pass through the second connecting path 53.

The process involved when conveying thick matter corresponds to the embodiment with two pistons 26, 27, subject to the difference that the shut-off valve 52 shuts off the second connecting path 53 during each conveying movement, while the first piston 26 moves along the first connecting path 33 during each conveying movement. In the transitional phase between two conveying movements of the piston 26, the shut-off valve 52 is moved to the side, so that it opens up the second connecting path 53. The piston 26 can pass through the shut-off valve 52 and move on to the next conveying movement.

In the embodiment according to FIG. 16, the thick matter pump comprises three pistons 26, 27, 56 and two outlet openings 25, 55 which open out into a shared outlet pipe 57. The transitional phase, in which the first piston 26 moves between the second outlet opening 55 and the inlet opening 24, is bridged by the third piston 56 being arranged between the first outlet opening 25 and the second outlet opening 55. Because the second piston 27 has a higher speed than the first piston 26, thick matter is still conveyed through the outlet pipe 57, even though a part of the thick matter conveyed through the first outlet opening 25 flows back through the second outlet opening 55 to the rear side of the first piston 26. As soon as the second piston 27 travels over the first outlet opening 25, the third piston 56 and the second piston 26 are set in motion, so that the second piston 27 initially conveys thick matter with the end of its conveying movement through the second outlet opening 55, while the next conveying movement of the first piston 26, with which the first piston 26 conveys thick matter through the first outlet opening 25, can start in parallel. In this way, the interruption of the conveying flow which occurs with other embodiments of the thick matter pump and which results from two pistons moving together between the outlet opening and the inlet opening, or from the shut-off valve being opened, can be avoided.

1. A thick matter pump having a conveying chamber, which extends along a closed path from an inlet opening, via an outlet opening, back to the inlet opening, so that the conveying chamber forms a first connecting path and a second connecting path between the inlet opening and the outlet opening, having a first piston for performing a conveying movement along the first connecting path of the conveying chamber, so that with the conveying movement thick matter is conveyed from the conveying chamber through the outlet opening, and thick matter is introduced into the conveying chamber through the inlet opening, and having a shut-off element in the conveying chamber which shuts off the second connecting path in a first state, and opens up the second connecting path in a second state, in order to allow a movement of the first piston along the second connecting path, wherein a wall shell delimiting the conveying chamber is attached to the first piston, which wall shell extends over the entire length of the conveying chamber and is moved together with the first piston.

2. The thick matter pump of claim 1, wherein the wall shell has a greater extent in the circumferential direction than a connecting element which extends between a drive motor of the thick matter pump and the first piston.

3. The thick matter pump of claim 1, wherein the wall shell extends over a circumferential angle of at least 30°, preferably at least 60°, more preferably at least 90°.

4. The thick matter pump of claim 1, wherein the shut-off element is a shut-off valve which, in the first state, is arranged in the second connecting path and, in the second state, is spaced apart laterally from the second connecting path.

5. The thick matter pump of claim 1, wherein the shut-off element is a second piston which is likewise designed to perform a conveying movement along the first connecting path of the conveying chamber.

6. The thick matter pump of claim 5, wherein the second piston is at a standstill during the conveying movement of the first piston.

7. The thick matter pump of claim 5, wherein during the conveying movement of the first piston, the second piston is arranged in an intermediate position between the outlet opening and the inlet opening.

8. The thick matter pump of claim 5, wherein the conveying chamber comprises an inlet opening and two outlet openings and that three pistons are arranged in the conveying chamber.

9. The thick matter pump of claim 1, wherein a first wall shell of the first piston extends along a different circumferential portion of the conveying chamber to a second wall shell of the second piston.

10. The thick matter pump of claim 9, wherein the conveying chamber has a circumferential portion, which is kept free from the first wall shell and from the second wall shell and that the circumferential portion which is kept free is oriented to the inlet opening and the outlet opening.

11. The thick matter pump of claim 10, wherein the wall of the conveying chamber is formed in the circumferential portion that is kept free by a housing part of the thick matter pump.

12. The thick matter pump of claim 11, wherein the inlet opening and the outlet opening are arranged in the housing part.

13. The thick matter pump of claim 1, wherein a circumferential portion of the piston which travels over the inlet opening or the outlet opening is formed by an end piece made of hard metal.

14. The thick matter pump of claim 1, wherein an outlet of the thick matter pump is coupled with a supplementary conveying cylinder.

15. A method for conveying thick matter in which a first piston is moved in a conveying chamber, wherein the conveying chamber extends along a closed path from an inlet opening via an outlet opening back to the inlet opening, so that the conveying chamber forms a first connecting path and a second connecting path between the inlet opening and the outlet opening, wherein a wall shell which delimits the conveying chamber and extends over the entire length of the conveying chamber and which is moved together with the first piston is attached to said first piston, wherein in a first phase, the first piston is moved along the first connecting path from the inlet opening in the direction of the outlet opening, in order to convey thick matter through the outlet opening and to introduce thick matter through the inlet opening into the conveying chamber, while the second connecting path is shut off, and wherein in a second phase, the first piston is moved along the second connecting path.
